(19) United States
(12) Patent Application Publication
(10) Pub. No.: US 2005/0151662 A1
(43) Pub. Date: Jul. 14, 2005

(54) Avalanche transceiver

(76) Inventors: Douglas Kashuba, St. Albert (CA); Edward G. Pachal, St. Albert (CA); Cynthia G. Pachal, St. Albert (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/972,059

(22) Filed: Oct. 22, 2004

(30) Foreign Application Priority Data
Oct. 22, 2003 (CA) 2,443,751

(51) Int. Cl. G08B 21/00

(52) U.S. Cl. 340/690; 340/539.1; 702/2

(57) ABSTRACT

An improved battery-powered device and system for avalanche transceiver rescue. The device comprises a transmitter, a receiver, microcontroller firmware system, graphic display, audio speaker and input switches residing in a single portable housing with a flip lid. When the flip lid is closed, the system transmits a radio frequency signal at a predetermined interval. When the flip lid is opened, the system deactivates the transmitter and activates the receiver. The receiver comprises three mutually orthogonal tuned-coil antennas. The system digitally processes the received signal strength and polarity of the signal from one or more of the antennas to guide a user to a transmitting beacon. The antennas are spatially isolated permitting the use of higher-sensitivity antennas. The system digitally controls the sensitivity of each antenna enabling scans for signals based on a specified proximity range to the exclusion of other proximity ranges. The system also displays an indication when a degraded signal is received as a result of signal collision from multiple beacons.

### BACKGROUND OF THE INVENTION

1. Field of the Invention

The present invention is directed to rescuing victims accidentally buried in an avalanche. Each member of a group wears a battery-powered transceiver device in transmit mode which intermittently broadcasts a radio frequency signal at a predetermined frequency. In the event of accidental burial in snow, a non-buried member of the group changes their transceiver to operate in receive mode. Using signal strength, distance and/or orientation information from the transceiver, the searcher locates the position of the buried transmitted signal.

2. Description of the Prior Art

The state of the prior art is represented by two types of avalanche transceivers: (a) single-antenna analog transceivers and (b) dual-antenna digital transceivers. The apparatus described under U.S. Pat. No. 6,246,863 of Kampel is representative of the first type (analog). The apparatus described under U.S. Pat. No. 6,484,021 of Hereford et al is representative of the second type (digital). Each of these two types of transceivers has both advantages and disadvantages in different rescue scenarios.

(a) Proximity Indications and Flux Lines

Both types of transceivers provide proximity indications derived from the strength of the received signal which is converted to an intermediate frequency in the audible range and is routed to a speaker; the louder the volume of the sound, the closer the target. Additionally, some systems measure the signal strength and convert the value to either illuminate bars within a bar graph or to display a distance number. For bar graphs, the more number of bars illuminated, the closer the target. For distance numbers, the smaller the number, the closer the target.

When avalanche transceivers display a ‘distance’ indication, the displayed number does not convey a distance “as the crow flies”; rather, it conveys the distance along a flux line of the transmitted signal. A flux line is a curve of constant field strength emitted by a transmitting source. The shape of a flux line may be conceptualized in two dimensions as a figure eight with the transmitting source residing at the middle bar of the ‘eight’.

The orientation of the receiving antenna in relation to the flux line affects the received signal strength. The strongest measurement is obtained when the receiving antenna is aligned with the flux line (0-degree alignment). Alternatively, when the receiving antenna is aligned perpendicular to the flux line (90-degree alignment), a zero or null measurement is obtained. Alignments at any other angle produce measurements between that obtained for 0 and 90-degree alignments. The closer the angle is to 0 degrees, the stronger the received signal strength.

Using a single-antenna transceiver, a searcher points the device at the horizon and pans in a 360-degree circle looking for the closest proximity indication (louder, more bars, lower distance number). The searcher proceeds in the direction of the closest proximity indication. Because the closest indication occurs when the device is in 0-degree alignment with the flux line, the searcher is guided towards the transmitting beacon along the path of the flux line. This path is curved and is not the shortest path to the target. Also, because the path is curved, a searcher traveling in a straight line must realign the unit every 5 meters or so by performing another pan.

Using dual-antenna transceivers, left, right and center indications assist the searcher in aligning the device with the flux line. Because the two receiving antennas are oriented perpendicular to each other, the sum of the two alignment angles will approximate 90 degrees. When one antenna is aligned at 0 degrees, the other will be aligned at 90 degrees. When one is aligned at 45 degrees, so too will the other. When one is at 30 degrees, the other will be at 60. In the current implementation, two antennas of equal size are situated in the housing at 45 degrees to the center forward axis of the device forming a letter “X”. As long as the signal strength is equal for both antennas, the device is centered. When the top left-pointing antenna obtains a stronger signal, a left indication is provided. When the top right-pointing antenna is stronger, a right indication is provided.

This crossed dual-antenna implementation does break down, however, in close proximity to the burial. At close proximity, the degree of curvature in the flux line is greater and no longer approximates a straight line. This causes the 90-degree summing rule to deteriorate and, consequently, false left and right indications may occur.

Furthermore, flux lines are three-dimensional spheroids, rather than two-dimensional figure eights. The depth of the burial and orientation of the transmitting source determines which portion of the flux field is present on the surface of an avalanche snow pack. When a transmitting source is buried deeply in a horizontal position, only a small fraction of the top of the spheroid is present at the surface. When the transmitting source is buried in a vertical position, the flux field resembles the water in a fountain which spurts upward and cascades downward; on the surface, the field has the shape of a doughnut.

Whenever the flux field is precisely vertical, it becomes perpendicular to any device in the horizontal plane. Both single and dual antenna devices blank out when this situation occurs. Fortunately, searchers need only travel a short distance beyond this null region to regain signal indications as the null region is quite small. Some searchers tilt the transceiver upwards, downwards or sideways to confirm that the null region is in the horizontal plane only.

Because the orientation of the buried transmitting source is unknown, a searcher must take additional measurements within a few meters of the closest proximity indication. Experienced searchers use nulls, maxima and/or minima to bracket the burial. The deeper the burial, the larger the bracket area must be.

There is a need in the prior art to provide vertical orientation information and to prevent blanking of the transceiver in null regions, particularly for novice searchers unfamiliar with null regions who may become disconcerted when a unit blanks out.

(b) Antenna Size, Sensitivity and Range

The sensitivity of an antenna is directly related to its size; the larger the antenna, the more sensitive it is. A more sensitive antenna is capable of detecting signals at a greater distance range than less sensitive ones. Having a greater range of detection expedites the search of large areas. However, the antenna(s) contribute considerably to the size and weight of the transceiver unit. To be accepted by the industry, the unit must not be too big or too heavy so as to encumber a wearer during normal activities such as hiking or skiing.

Single-antenna analog transceivers use only one antenna but that antenna is larger and has a greater range. By contrast, in dual-antenna digital transceivers employing two matched and crossed antennas, the antennas must by necessity be smaller in order to fit within the same size portable housing as for the analog type. Consequently, dual antenna transceivers currently have a shorter distance range than the single-antenna types.

There is a need in the prior art to balance the size and weight of the receiving antenna(s). The receiving antenna(s) should be as large as possible to increase sensitivity and range, but not so large as to increase either the size and weight of current units.

(c) Multiple Burials

When multiple beacons are buried, it is possible for the radio signals transmitted by the beacons to collide. A collision occurs when the signals from two or more transmitting beacons combine in such a way as to interfere with each other. Any measurements taken during collisions are unrealiable. If the two signals are exactly the same frequency and also 180 degrees out of phase, the peaks and valleys of the signals will combine to wipe out both signals and the receiver will fail to detect either signal. More commonly, the two signals will have nearly the same frequency at 457 kHz, although not exact, and will combine partially in phase resulting in a degraded and/or erratic signal at the receiving antenna.

To assist with locating multiple burials, beacons do not continuously transmit a signal. Rather, a signal is transmitted for only a small portion of every 0.5 to 1.3 second interval. This standard protocol not only reduces battery power consumption but provides a time gap between transmissions for detection of signals from other beacons.

In the case where two beacons have colliding signals and the beacons have the same transmission interval, several minutes may pass before the signals stop colliding and start becoming reliable. The unreliability of colliding signals increases the time to recovery which may be detrimental to the survival of the buried beacon owners.

Even when there are no collisions between multiple beacons, locating a second beacon after the first beacon has been located is difficult using the apparatus of Hereford et al. That apparatus provides a masking capability whereby signals outside of a narrow window are ignored. A searcher positions the unit such that the center of the flux line of the second target remains within the search window. If, however, the searcher wanders off of the flux line path, which is frequent given that the path is curved, the appartus loses the second beacon and picks up the stronger first beacon.

In this respect, analog transceivers are considered by some as superior. By manually controlling the sensitivity using a range dial, a searcher can contract or expand the search area thereby selectively including or excluding beacons by proximity. Unfortunately, increasing the sensitivity to expand the search area to include a second beacon does not exclude receiving signal indications from the closer first beacon. The audio indications are crucial in enabling the searcher to discriminate between indications from two or more beacons.

In the case of mutiple beacons, there is a need in the prior art to identify signals degraded by collisions which are unreliable. There is also a need to minimize the time during which signals collide. Furthermore, there is a need to improve the method of finding a second burial after the first has been located.

(d) Secondary Avalanche and Switching Back to Transmit from Receive

An avalanche victims beacon must be in the transmit mode to be located. There is a need in prior art to provide a reliable way to ensure the victims beacons returns to the transmit position in the event of an avalanche. Currently there are two process used to switch from receive to transmit. The most common is a mechanical switch which the user must manually activate switch modes. The second incorporates a passive tack switch which signals the microprocessor to switch between modes for a set period of time. There is a need in the prior art to provide a switching mechanism that would be activated by the avalanche.

### SUMMARY OF THE INVENTION

The present invention comprises three mutually orthogonal antennas. This differs from the apparatus of Hereford et al in that an actual third vertical antenna is used, rather than a virtual antenna. By using an actual antenna, a signal is always received in close proximity to a burial regardless of the orientation of the buried transmitter. This is an improvement over both types of prior transceivers which provide no indications in null regions. In the present invention, the apparatus displays proximity and/or alignment indications in null regions rather than nothing.

Furthermore, each of the three receiving antenna is of different size and are spatially isolated one from the other. This differs from the matched and crossed dual-antenna implementation of the apparatus of Hereford et al for which the two antenna are of equal size and directly lying one on top of the other in the form of the letter “X”.

The present invention employs a digital implementation of the analog range switch found on prior analog transceivers which is useful in locating multiple burials. The present invention improves upon the analog range switch in that the system operates in one of several receive modes which assist in multiple burial scenarios. A searcher may select indications for all beacons or for the strongest. A searcher may also select a scan by distance range or may limit indications to a specific range or subset of ranges. The search for a second beacon after a first has been found is simplified when displayed indications are for one beacon only.

The firmware of the present invention synthesizes audio indications. This differs from prior transceivers in which audio indications are derived from an intermediate frequency of the received signal.

The firmware of the present invention digitally processes the received beacon signal to determine the reliability of the signal. When the signal is degraded, a multiple beacon collision indicator is illuminated indicating to a searcher that a signal was received but that it is unreliable. This differs from both types of transceivers in the prior art which display indications as if a valid signal had been received.

The present invention comprises a transmitter capable of transmitting a constant wave radio signal at a predetermined frequency. The system provides a means for users to select different transmission intervals. When each member of a group selects a different transmission interval, the occurence of collisions in the event of multiple burials is significantly reduced. Although collisions are not completely eliminated, the time span during which consecutive collisions occur is limited to within a few seconds. This is a significant improvement over prior transceivers which, when all beacons have the same interval, may have had consecutive collisions for several minutes.

The present invention employs a housing which has a flip lid design which protects the sensitive display and control area. This differs from current transceivers in the prior art which leave the controls and display area unprotected from the weather elements, abuse, and the forces of an avalanche.

The present invention has a housing with a flip lid design in which the switching from transmit to receive mode is activated by opening the flip lid and revealing the display and search controls. The design is such that the receive mode is activated when the flip lid is opened to the optimum viewing angle. If the lid is positioned at any position other than that of the optimum viewing angle the apparatus remains in the transmit mode.

### BRIEF DESCRIPTION OF THE DRAWINGS

FIG. 1 illustrates a flux field for a horizontal burial in both (a) side view and (b) top view. From the side, the flux field is shaped like a figure eight with the transmission source forming the middle bar of the eight. From the top, the flux field at the surface of the snow is shaped as an ellipsoid.

FIG. 2 illustrates a flux field for a vertical burial in both a (a) side view and (b) top view. From the side, the flux field is shaped like a figure eight on its side. From the top, the flux field at the surface of the snow is shaped like a doughnut.

FIG. 3(a), 3(b) and 3(c) illustrate the method of using the relative polarity of two orthogonal antennas to provide alignment indications.

FIG. 4 illustrates a front view of the preferred embodiment of the avalanche transceiver.

FIG. 5 illustrates a side view of the preferred embodiment of the avalanche transceiver.

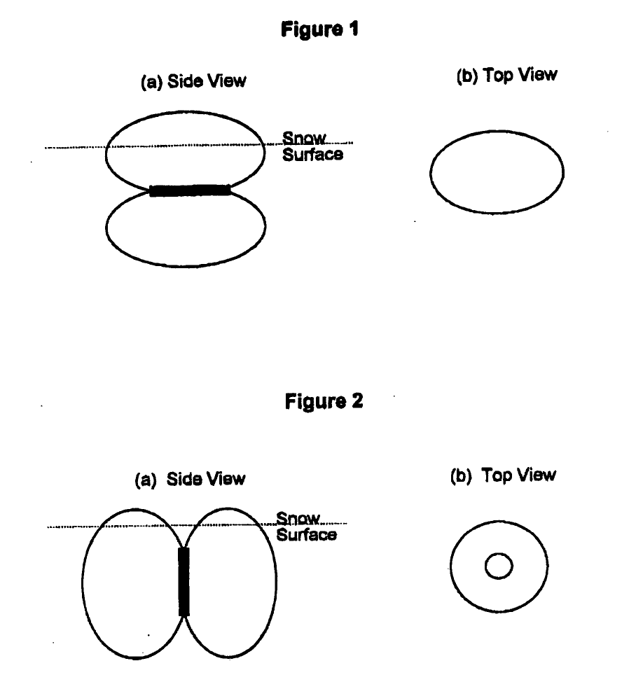

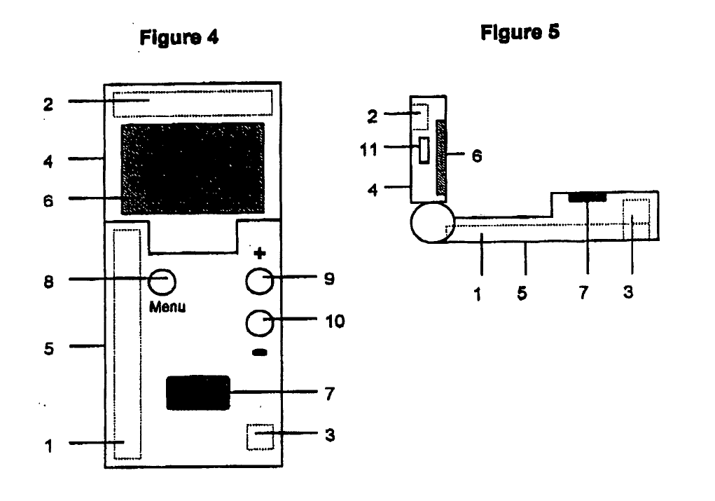

Both FIG. 4 and FIG. 5 illustrate the spatial separation and orientation of the three antennas within the main housing and flip lid. These figures also show a microprocessor, graphic display area, speaker and user input buttons.

### DETAILED DESCRIPTION OF THE PREFERRED EMBODIMENT(S)

As illustrated in FIG. 4 and FIG. 5, the present invention comprises a receiver with three mutually orthogonal receiving antennas 1, 2 and 3. Antenna 1 is oriented in the forward/backward direction of the housing. Antenna 2 is oriented in the left/right direction while antenna 3 is oriented in the up/down direction. In the preferred embodiment, the antennas are tuned-coil antennas receiving signals at 457 kHz. In another embodiment, the antennas are tuned to receive at 398 kHz for snowmobilers.

In the present invention, antenna 1 is the largest antenna. Antennas 2 and 3 are smaller in size and are located away from antenna 1. By spatially isolating antennas 2 and 3 away from antenna 1, each antenna has a higher sensitivity and, consequently, a higher range of operation. FIG. 4 and FIG. 5 show antenna 2 located in the flip lid 4 while antennas 1 and 3 are located in the main housing 5. While this is the preferred embodiment, other embodiments with different antenna locations are possible.

Antenna 3 is required by the system for two purposes: it permits proximity indications in null regions and provides vertical alignment indications. Because null regions and changes to vertical alignment only occur when in close proximity to the buried transmission source, and because signals are considerably stronger at close proximity, antenna 3 can be considerably smaller than 1 or 2. In the preferred embodiment, the thickness of the housing is substantially the same as that for previous transceivers.

The system of the present invention comprises a microprocessor 11 operably connected to each of the antennas. The system utilizes logic switching to enable a specific antenna and appropriate circuitry to direct the signal to a standard RF receiver chip. The strength of an incoming signal is measured using the analog received signal strength indication (RSSI) from the RF receiver chip fed into an analog-to-digital converter present within the microprocessor 11. From the derived digital signal strength, the firmware computes an estimate of distance which is displayed numerically. In the preferred embodiment, the display area 6 is a dot matrix display. In other embodiments, the display area may include seven-segment light emitting diodes (LEDs).

The system also digitally processes an intermediate frequency (IF) signal to determine the reliability of the signal. The firmware digitally captures the edges of the incoming sinusoidal wave. Using a sample of such edges, the firmware computes an average interval and standard deviation. In cases where the signal strength is above the noise threshold but the average interval and/or standard deviation falls outside of acceptable limits, the system displays an indication to the searcher that a signal was received but that it is unreliable. The firmware does not provide proximity or alignment indications when a degraded signal indication is given. In the preferred embodiment, the word “MULTIPLE” or icon symbolizing a multiple is displayed on the dot matrix display as the degraded signal indication. In another embodiment, a labelled LED is illuminated.

The system computes the relative polarity of two antennas using back-to-back edge samples of the signals. In the preferred embodiment, falling edges are captured using a standard edge-capture capability of the microprocessor 11. In another embodiment, rising edges are captured. The time of the last edge of the first sample is subtracted from the time of the first edge of the second sample. This difference is then divided by the average interval. If the remainder after division is approximately zero, then the two antennas have the same polarity. If the remainder is approximately 50% of the average interval, then the two antennas have different polarity.

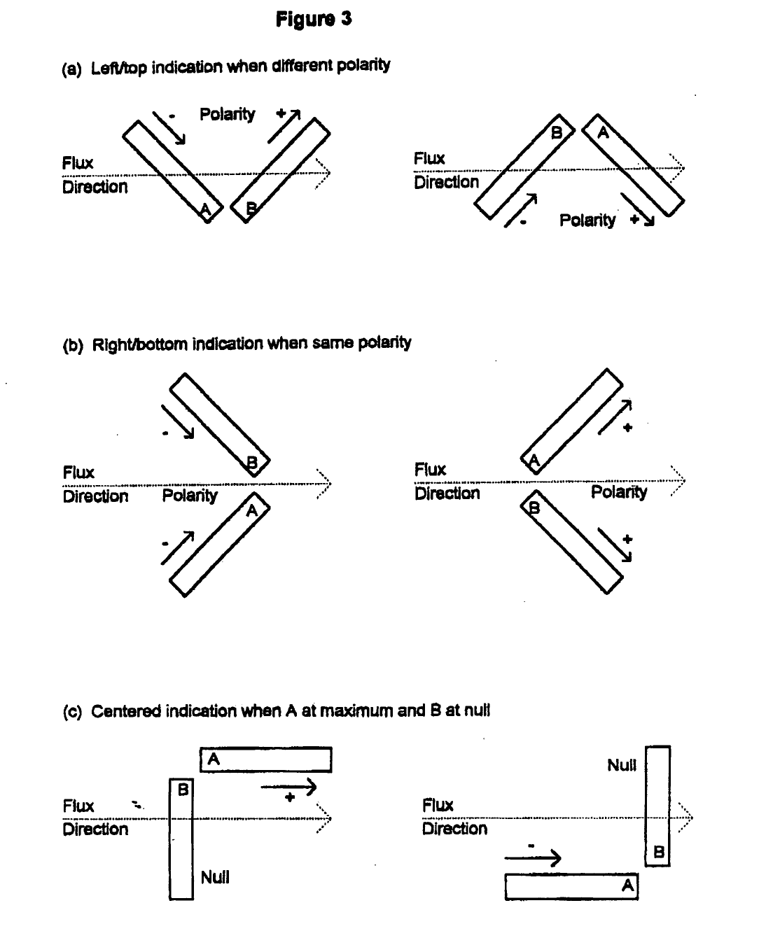

FIG. 3 illustrates how alignment indications are derived from relative polarity. The polarity of an antenna is positive when the direction of the flux lines causes movement from the base of the antenna, labelled with “A” or “B”, towards the top of the antenna. The polarity is negative when the direction is from the top to the base. For horizontal alignment indications of left, right and center, the X antenna is represented by “A” and the Y antenna by “B”. For vertical alignment indications of top, bottom and center, the Z antenna is represented by “A” and either the X or Y antenna is represented by “B”.

When two antennas have different polarity, a left horizontal or top vertical alignment indication is given. When the two antennas have the same polarity, a right horizontal or bottom vertical alignment indication is given. When one antenna has a signal significantly stronger than another, a center indication is given.

The preferred embodiment contains a speaker 7, operably connected to the microprocessor 11. The firmware synthesizes audio indications using the standard pulse width modulation (PWM) capability of the microprocessor 11. During the display of distance and/or alignment indications, an audio tone is emitted the pitch of which varies according to the signal received. The audio indication assigns a higher pitch when the transmission source is closer in proximity and a lower pitch when further away. In multiple beacon scenarios, signals are separated by varying the pitch making it easier to discriminate between beacons. it is easier to discriminate between beacons by varying the pitch rather than the volume.

The system of the present invention controls the sensitivity of each antenna by writing a load value to a digital latch which controls the attentuation of the antenna by way of circuitry. The larger the load value, the less sensitive the antenna. Using a zero load value, the antenna is most sensitive. Using a maximum load value, the antenna is disabled.

Each proximity range has a specific load value associated with it. For a given load value, the RSSI signal will be below the noise threshold when the transmission source is not close enough to the receiver for the range, and will be above the saturation threshold when the transmission source is closer to the receiver than allowed for the range.

By utilizing different load values, the system is able to narrow or broaden a search area. Zero load values are used to find all beacons within the broadest search area possible. High load values are used for searches restricted to close proximity to a transmission source.

In the preferred embodiment, several receive modes are provided to assist users in possible search scenarios. Modes are selected by way of a menu switch 8. In “Auto” mode, the system displays indications for all beacons in the broadest search area. The system automatically selects a load value corresponding to the range of the current received signal. In a single burial scenario, this is the only mode required to locate a transmission source. In a multiple burial scenario, one of the other available modes may be utilized. In “Forward” mode, the system displays indications for the strongest signal only. In “Scan” mode, the system cyclically ascends and descends through each possible range displaying indications for signals isolated within the current range. In “Seek” mode the system can be prompted to cyclically ascend or descend, locking onto and displaying indications for a specific signal until prompted to continue. In “Forward narrow” mode, the system restricts indications to the strongest signal whose horizontal alignment is within 15 degrees of centered. In “Manual” mode, the searcher specifically selects a range or subset of ranges at which to focus the search using the + and − buttons, labelled 9 and 10 in FIG. 4.

In the preferred embodiment, the system provides a menu function for users to display and/or select different transmission intervals. By default, a transmission interval is selected randomly. A user may view the selected interval and manually change it. The preferred embodiment allows for a plurality of different intervals varying between 0.7 seconds and 1.3 seconds in steps of 0.1 seconds. Each transmission interval has a duty cycle of 25 percent plus or minus 15 percent.

In the preferred embodiment, the housing design is such that the normal transmit position is when the lid of the devise is closed protecting the search controls and display area. To activate the search mode the flip lid must be opened to the fixed receive position which coincides with the optimum viewing angle. When the flip lid is opened to varying degrees of positions other than the fixed receive position the unit will remain in the transmit mode. The flip lid of the devise can be forced past the fixed receive position, doing so to any degree will cause the devise to revert back to the transmit mode.

1. An avalanche transceiver comprising:
a housing;
a transmitter, located within said housing, that is capable of transmitting a radio signal at a predetermined frequency;
a receiver, located within said housing, that includes three antennas each capable of receiving a radio signal at a predetermined frequency;
a processor, operably associated with said receiver, that is capable of: (a) selecting one or more of the said antennas, (b) controlling the sensitivity of an antenna, and (c) digitally processing received signals to measure signal strength and/or relative polarity; and
a display, operatively attached to said housing, that is capable of providing a user with one or more of the following visual indications of the received flux field: (a) proximity, (b) horizontal alignment and (c) vertical alignment.

2. An avalanche transceiver as claimed in claim 1, wherein the receiver, located within said housing, includes three antennas each capable of receiving a radio signal at a predetermined frequency which are somewhat mutually orthogonal.

3. An avalanche transceiver as claimed in claim 1 wherein the processor, operably associated with said receiver, is capable of: (a) selecting one or more of the said antennas, (b) controlling the sensitivity of an antenna by variable attenuation, and (c) digitally processing received signals to measure signal strength and/or relative polarity.

4. An avalanche transceiver as claimed in claim 1, wherein the housing comprises a flip lid which: (a) when closed causes the transceiver to operate in a transmit mode, and (b) when open causes the apparatus to operate in a receive mode.

5. An avalanche transceiver as claimed in claim 4, wherein search controls and the display are protected and/or concealed under the flip lid.

6. An avalanche transceiver as claimed in claim 4, wherein one or more of the three antennas is located within the flip lid.

7. An avalanche transceiver as claimed in claim 1, wherein the housing comprises a flip lid which when open provides spatial separation between one or more of the three antennas.

8. An avalanche transceiver as claimed in claim 1, wherein the housing comprises a flip lid which when closed induces a radiated signal from one antenna into the other two antennas which in turn activates their load control circuitry eliminating any disruption to the standard transmitted field pattern from the said antenna.

9. An avalanche transceiver as claimed in claim 1, further comprising:
a speaker, located within said housing, capable of emitting an audible tone; and
a processor, operably attached to said speaker, which is capable of generating synthesized tones and which provides a user with an audible distinction and/or proximity indication based on pitch.

10. An avalanche transceiver as claimed in claim 1, wherein different sensitivity levels of the antennas in the receiver are represented in the interface display by a plurality of ranges.

11. An avalanche transceiver as claimed in claim 10, wherein the transceiver is further configured to limit radio and/or visual indications from received signals to one range or to any subset of ranges.

12. An avalanche transceiver as claimed in claim 1, further comprising a visual degraded signal indication which informs a user that a signal has been received but that proximity and/or alignment indications are not reliable because the received signal is degraded, whether caused by collision of signals from multiple beacons or otherwise.

13. An avalanche transceiver as claimed in claim 1, wherein the transceiver is further configured to select one of a plurality of unique transmission intervals at which the transceiver will transmit a signal while operating in a transmit mode.

14. An avalanche transceiver as claimed in claim 1, wherein the housing comprises a flip lid which has (a) a plurality of unfixed transmit mode positions, and (b) a single fixed receive mode position.

15. An avalanche transceiver as claimed in claim 2, wherein the housing comprises a flip lid which when open provides spatial separation between one or more of the three antennas.

16. An avalanche transceiver as claimed in claim 2, wherein the housing comprises a flip lid which when closed induces a radiated signal from one antenna into the other two antennas which in turn activates their load control circuitry eliminating any disruption to the standard transmitted field pattern from the said antenna.

17. An avalanche transceiver as claimed in claim 2, wherein the housing comprises a flip lid which has (a) a plurality of unfixed transmit mode positions, and (b) a single fixed receive mode position.
